(19) United States
(12) Patent Application Publication
(10) Pub. No.: US 2019/0123337 A1
(43) Pub. Date: Apr. 25, 2019

(54) NEGATIVE ELECTRODE FOR LITHIUM SECONDARY BATTERY AND LITHIUM SECONDARY BATTERY

(71) Applicant: NEC CORPORATION, Tokyo (JP)

(72) Inventor: Takuya HASEGAWA, Tokyo (JP)

(73) Assignee: NEC Corporation, Tokyo (JP)

(21) Appl. No.: 16/082,689

(22) PCT Filed: Mar. 29, 2017
(86) PCT No.: PCT/JP2017/012968

§ 371 Date: Sep. 6, 2018

(30) Foreign Application Priority Data
Apr. 15, 2016 (JP) 2016-082179

(51) Int. Cl. H01M 4/131; H01M 4/134; H01M 4/38; H01M 2/30; H01M 10/0525

(52) U.S. Cl. CPC H01M 4/131; H01M 4/134; H01M 2004/027; H01M 2/30; H01M 10/0525; H01M 4/386

(57) ABSTRACT

In order to provide a negative electrode for a lithium secondary battery providing a high electrode density, i.e., a high volumetric energy density, and improved in life characteristics and a lithium secondary battery using the negative electrode, the present invention uses a negative electrode for a lithium secondary battery, in which a negative electrode active material layer (2a, 2b) formed on a negative electrode current collector 3 comprises at least first particles 4, second particles 5 and a binder 6, the first particles 4 are formed of SiO_{χ} (0<χ<2.0), the second particles 5 are formed of a Si alloy, the Si alloy comprises Si and at least one element selected from metal elements except Li, Mn, Fe, Co and Ni and semimetal elements, and the central particle size D50 of the first particles 4 is larger than the central particle size D50 of the second particles 5.

### TECHNICAL FIELD

The present invention relates to a negative electrode for a lithium secondary battery, including a mixture of a silicon oxide and a silicon alloy as an active material. The present invention also relates to a lithium secondary battery including the negative electrode.

### BACKGROUND ART

Recently, for expanding the use of electric vehicles (xEV), it is necessary to increase the driving distance per charge. Lithium secondary batteries used as the power sources for xEV are strongly desired to have a high energy density in view of weight saving.

For increasing the energy density, increasing the capacity of a battery is one of the solutions. Using a solid-solution positive electrode material constituted of Li₂MnO₃ as a matrix structure in a positive electrode and a negative electrode material constituted of an alloy mainly based on silicon and silicon oxide in a negative electrode is mentioned as a method (Patent Literature 1).

Silicon has a theoretical capacity of 4200 mAh/g, which is extremely higher than the theoretical capacity (372 mAh/g) of a carbon material (graphite) presently primarily used in practice; however the volume thereof significantly changes by charge/discharge. Because of this volume change, a decrease of battery capacity is a matter of concern (Patent Literature 2).

In contrast, silicon oxide, SiO_{χ}, provides a relatively high capacity and has satisfactory life characteristics. However, since an initial charge/discharge efficiency thereof is low, an effect of increasing the energy density of a battery is not sufficient (Patent Literature 3).

Recently, use of an alloy of silicon and another metal (hereinafter referred to as a Si alloy) has been investigated. Patent Literature 4 proposes use of a silicon solid-solution having one or more semimetal elements (except silicon) belonging to Group 3 to Group 5 incorporated in silicon, as a negative electrode active material, in which the element incorporated in silicon is abundantly present on the crystal grain boundaries of the silicon solid solution than the inside the crystal grains.

Further, Patent Literature 5 proposes use of particles of a transition metal-silicon alloy, which contains the same transition metal as used in a lithium transition metal oxide serving as a positive electrode active material and Si, as a negative electrode active material.

### CITATION LIST

### Patent Literature

Patent Literature 1: International Publication No. WO 2012/120782

### Patent Literature 2: JP5-74463A

### Patent Literature 3: JP6-325765A

Patent Literature 4: International Publication No. WO 2013/002163

### Patent Literature 5: JP2013-62083A

### SUMMARY OF INVENTION

### Technical Problem

A negative electrode including a silicon oxide (hereinafter referred to as SiO_{χ}) has a high capacity; however the initial charge/discharge efficiency is low. In addition, the true density of SiO_{χ} is low so that it is difficult to increase the density of the electrode. A negative electrode including a Si alloy has higher initial charge/discharge efficiency than a negative electrode including SiO_{χ}. The true density of the Si alloy is high so that the electrode density can be increased. However, there is a problem that the cycle life is short.

An object of the present invention is to provide a negative electrode for a lithium secondary battery providing a high electrode density, i.e., a high volumetric energy density and improved in life characteristics, and a lithium secondary battery using the negative electrode.

### Solution to Problem

According to one aspect of the present invention, there is provided a negative electrode for a lithium secondary battery having a negative electrode active material layer formed on a collector, in which the negative electrode active material layer includes at least first particles; second particles and a binder, and the first particles are formed of SiO_{χ} (0<χ<2.0); the second particles are formed of a Si alloy; the Si alloy includes Si and at least one element selected from metal elements except Li, Mn, Fe, Co and Ni, and semimetal elements; and the central particle size D50 of the first particles is larger than the central particle size D50 of the second particles.

According to another aspect of the present invention, there is provided a lithium secondary battery including the above-mentioned negative electrode for a lithium secondary battery.

### Advantageous Effects of Invention

According to one aspect of the present invention, it is possible to provide a negative electrode for a lithium secondary battery providing a high volumetric energy density and improved in life characteristics and a lithium secondary battery using the negative electrode.

### BRIEF DESCRIPTION OF DRAWINGS

FIG. 1 is a schematic sectional view of the negative electrode for a lithium secondary battery according to an example embodiment.

FIG. 2 is a configuration diagram of a laminated lithium ion secondary battery according to an example embodiment.

FIG. 3 is a cross sectional view of an electrode stack according to an example embodiment.

FIG. 4 is a graph showing a change of discharge capacity with ascending number of cycles in Examples and Comparative Examples of the present invention.

FIG. 5 is a graph showing a change of the volumetric energy density with ascending number of cycles in Examples and Comparative Examples of the present invention.

### EXAMPLE EMBODIMENTS

Now, example embodiments will be described with reference to the drawings; however, the present invention is not limited to the example embodiments alone.

### [1] Negative Electrode for Lithium Secondary Battery

(1) Structure of Negative Electrode for Lithium Secondary Battery

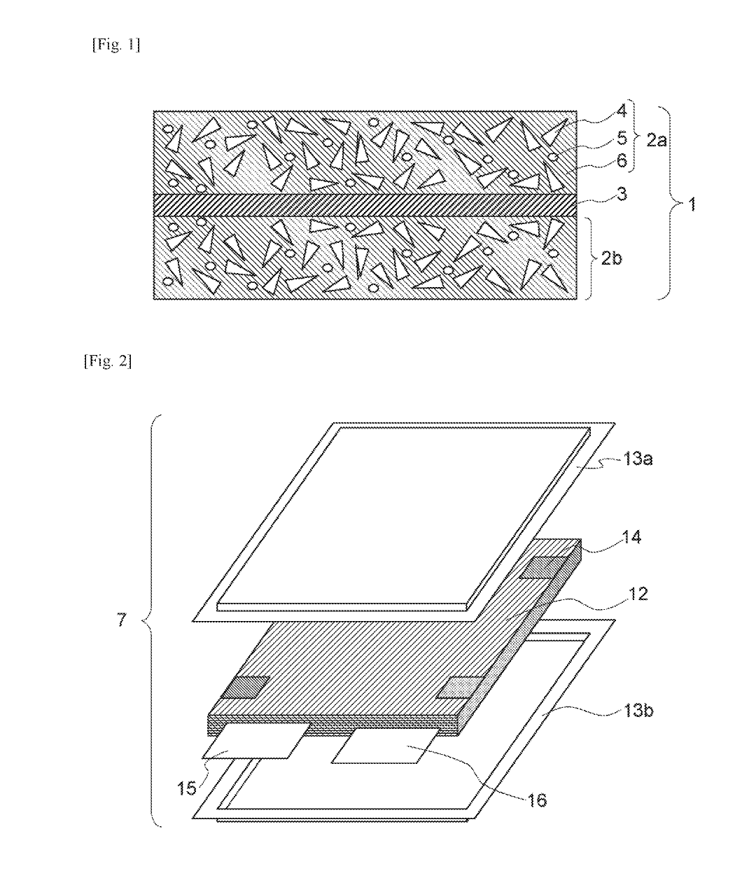

FIG. 1 shows a schematic sectional view of a negative electrode 1 for a lithium secondary battery according to an example embodiment. The negative electrode 1 for a lithium secondary battery shown in FIG. 1 has negative electrode active material layers 2a, 2b and a negative electrode current collector 3. The negative electrode active material layers 2a, 2b each include at least first particles 4, second particles 5 and binder 6. The first particles 4 are formed of SiO_{χ} (0<χ<2.0) and the second particles 5 are formed of a Si alloy. The Si alloy includes Si and at least one element selected from metal elements except Li, Mn, Fe, Co and Ni, and semimetal elements. The central particle size D50 of the first particles 4 is larger than the central particle size D50 of the second particles 5.

(Negative Electrode Active Material)

In a negative electrode active material according to the example embodiment, the first particles, which are formed of SiO_{χ} (0<χ<2.0), can have a cluster structure or an amorphous structure, and the surface of the particles can be coated with a conductive material. The conductive material includes a carbon material such as graphite, amorphous carbon, diamond-like carbon, fullerene, carbon nanotube and carbon nanohorn, a metal material, an alloy material or an oxide material.

The second particles are formed of a Si alloy, and the Si alloy includes Si and at least one element selected from metal elements except Li, Mn, Fe, Co and Ni, and semimetal elements. Note that pure Si is not regarded as an alloy.

The central particle size D50 of the first particles 4 formed of SiO_{χ} included in the negative electrode active material layer 2 is not particularly limited; however, for example, D50 is preferably 1 μm or more and 35 μm or less, more preferably 2 μm or more and 10 μm or less, and further preferably 3 μm or more and 6 μm or less. Usually, powdery SiO_{χ} to be used in the negative electrode active material of a lithium ion secondary battery is produced by grinding a silicon oxide raw material having a certain size.

The silicon oxide powder herein has a SiO₂ film formed on the surface. The SiO₂ film herein serves as an insulator when the silicon oxide is used as the negative electrode active material of a lithium ion secondary battery, with the result that resistance is generated and an electrolyte is decomposed. For these reasons, the SiO₂ film formed on the surface of silicon oxide fine powder becomes a causative factor of decreasing initial efficiency and cycle characteristics of a lithium ion secondary battery.

Powdery silicon oxide obtained by grinding contains a large amount of fine powder having a diameter of less than 1 μm, which is generated in the grinding. If silicon oxide has a large amount of fine powder, the surface area per unit mass increases, in other words, the area of the SiO₂ film formed on the surface increases. Accordingly, when silicon oxide is used as the negative electrode active material of a lithium ion secondary battery, the silicon oxide having a central particle size D50 of 1 μm or more is preferably used in order to prevent a decrease of the initial efficiency and deterioration of cycle characteristics.

If the central particle size D50 exceeds 35 μm, a number of huge silicon oxide particles come to be contained. In this case, if the silicon oxide, a conductive aid and a binder are mixed and used as a negative electrode material for a lithium ion secondary battery, lithium ions cannot get into the interior portion of a huge silicon oxide particle. As a result, the performance of SiO_{χ} cannot be sufficiently provided, with the result that the initial efficiency decreases. Accordingly, the central particle size D50 is preferably 35 μm or less.

Second particles 5 formed of Si alloy have a smaller central particle size D50 than the first particles. For example, the central particle size D50 thereof is preferably 0.1 μm or more and 5 μm or less, more preferably 0.1 μm or more and 3 μm or less and further preferably, 0.1 μm or more and 2 μm or less. If the central particle size D50 thereof is 5 μm or less, it is possible to suppress reduction in particle size due to volume change and degradation of battery characteristics caused by formation of lithium dendrite in charging time. In contrast, if D50 is 0.1 μm or more, an increase of contact resistance can be suppressed.

If the central particle size D50 of the second particles is larger than D50 of the first particles, expansion of volume is large, with the result that initial charge/discharge efficiency significantly decreases and cycle characteristics significantly degrade. For this reason, the central particle size D50 of the first particles must be larger than D50 of the second particles. Note that, the central particle size D50 of the active material can be measured by a laser diffraction/scattering type particle size distribution measuring device.

In order to increase conductivity, the surface of the first particles 4, SiOₓ, is preferably covered with carbon. The mass ratio of SiO_{χ} and the surface-covered carbon can fall within the range of 99.9/0.1 to 80/20. If the mass ratio falls within this range, the contact resistance between particles is reduced; reduction of SiO_{χ} ratio and negative electrode capacity can be avoided. The mass ratio more preferably falls within the range of 99.5/0.5 to 85/15, and further preferably within the range of 99/1 to 90/10.

The second particles 5, Si alloy, preferably has an initial charging capacity of 4000 mAh/g or less and 1000 mAh/g or more when Li is used as a counter electrode. The theoretical capacity of Si is 4200 mAh/g; however, if the initial charging capacity is 4000 mAh/g or less, a large volume change by charge/discharge is suppressed, with the result that deterioration of the battery can be prevented. If the initial charging capacity is 1000 mAh/g or more, an advantage: high energy density of the battery, can be obtained. The initial charging capacity is more preferably 2000 mAh/g or more and 3800 mAh/g or less and further preferably 2500 mAh/g or more and 3500 mAh/g or less.

Note that, the initial charging capacity can be obtained by charging the battery within the range of 0.02 V to 1 V at 25° C.

As the Si alloy, for example, an alloy of silicon (Si) and a metal element is used in order to increase true density and obtain a high volumetric energy density. Examples of the metal element include beryllium (Be), magnesium (Mg), aluminum (Al), scandium (Sc), titanium (Ti), vanadium (V), chromium (Cr), copper (Cu), zinc (Zn), gallium (Ga), yttrium (Y), zirconium (Zr), niobium (Nb), molybdenum (Mo), palladium (Pd), ruthenium (Ru), cadmium (Cd), indium (In), tin (Sn), tantalum (Ta), tungsten (W), platinum (Pt), gold (Au), lead (Pb) and bismuth (Bi). Also, an alloy of silicon and a semimetal can be used. Examples of the semimetal include metals except silicon, such as boron (B), germanium (Ge), arsenic (As), antimony (Sb) and tellurium (Te). However, as a metal of Si alloy, lithium (Li), manganese (Mn), cobalt (Co), nickel (Ni) and iron (Fe) are excluded, because these elements are frequently used in a positive electrode material (e.g., LiMn₂O₄, Li₂MnO₃, LiNiO₂, LiFePO₄) of a battery. If Li, Mn, Ni and Fe, which easily elute and precipitate, are used in a Si alloy, ions of these metals are preferentially deposit on the Si alloy particles, with the result negative electrode resistance tends to increase and battery characteristics can degrade.

Provided that the Si alloy is represented by Si_{1-ψ}Mψ where M represents a metal or semimetal constituting the Si alloy together with silicon, the range of ψ is preferably 0.01 or more and 0.5 or less. If ψ is 0.5 or less, a reduction of the initial charging capacity of the silicon alloy is suppressed, with the result that a high capacity of 1000 mAh/g or more can be attained. In addition, a decrease of the energy density of a battery can be suppressed. If ψ is 0.01 or more, single crystallization of silicon can be suppressed and a volume change associated with charge/discharge and causing deterioration of a battery decreases compared to pure silicon. The range of ψ is more preferably 0.02 or more and 0.4 or less and further preferably 0.03 or more and 0.3 or less.

Provided that the mass ratio of the second particles 5 relative to the total mass of the first particles 4 and the second particles 5 is represented by ω, ω is preferably larger than 0% and 50% or less, more preferably 1% or more and 40% or less and further preferably 5% or more and 20% or less. If the ratio of the second particles increases, volumetric energy density increases; however, the amount of Si alloy, which is likely to cause cycle deterioration associated with charge/discharge, increases. As a result, the cycle life of the battery becomes short. If the ratio of the second particles is low, the effect of increasing energy density becomes low.

(Binder)

As the binder 6, for example, polyimide, polyamide, polyacrylic acid, polyvinylidene fluoride, polytetrafluoroethylene, carboxymethyl cellulose and modified acrylonitrile rubber particles can be used. The amount of binder for a negative electrode to be used herein is preferably 7 to 20 parts by mass relative to the negative electrode active material of 100 parts by mass in consideration of trade off relationship between “sufficient bonding force” and “imparting high energy”.

(Other Additives)

To the negative electrode active material layer, a conductive aid can be added other than the first particles 4 and the second particles 5 serving as a negative electrode active material, and the binder 6. As the conductive aid, e.g., carbon black, carbon fiber and graphite can be used alone or in combination of two types or more.

(Negative Electrode Current Collector)

As the negative electrode current collector 3, copper, stainless steel, nickel, cobalt, titanium, gadolinium or an alloy thereof can be used, and particularly, stainless steel is preferably used. As the stainless steel, martensite type, ferrite type or austenite/ferrite two-phase type can be used. For example, number JIS 400s in martensite type such as SUS 420J2 having a chromium content of 13%, number JIS 400s in ferrite type such as SUS 430 having a chromium content of 17% and number JIS 300s in austenite/ferrite two-phase type such as SUS 329 J4L having a chromium content of 25%, a nickel content of 6% and a molybdenum content of 3%, can be used. Alternatively, a composite alloy of these can be used.

(Method for Manufacturing Negative Electrode)

The negative electrode 1 for a lithium secondary battery according to an example embodiment of the present invention can be manufactured as follows. A negative-electrode mix is prepared by homogeneously mixing the first particles 4, second particles 5 and binder 6. The mix is dispersed in an appropriate dispersion medium such as N-methyl-2-pyrrolidone (NMP) to prepare a negative-electrode mix slurry. The negative-electrode mix slurry obtained is applied to one or both surfaces of a negative electrode current collector and dried to form a negative electrode active material layer. At this time, pressure can be applied for molding. As the application method, which is not particularly limited, a method known in the art can be used. For example, a doctor blade method and a die coater method can be mentioned. Alternatively, a negative electrode active material layer is formed in advance, and thereafter, a thin-metal film serving as a negative electrode current collector can be formed by a deposition method or a sputtering method to form a negative electrode current collector.

In the negative electrode for a lithium secondary battery according to the present invention, an active material is prepared by homogeneously mixing the second particles, Si alloy, having a higher initial charge/discharge efficiency than SiO_{χ} and a high true density, with the first particles, SiO_{χ} having a low initial charge/discharge efficiency and a low true density. Owing to this, the electrode density is increased and the charge/discharge efficiency is improved. In addition, if the median diameters of the first particles and the second particles are controlled as mentioned above, volumetric expansion of the metal and alloy phase can be sufficiently effectively reduced, with the result that a secondary battery having an excellent balance among the energy density, cycle life and charge/discharge efficiency can be obtained.

In the above manner, a negative electrode for a lithium secondary battery providing a high volumetric energy density and improved in life characteristics can be obtained and a lithium secondary battery using the negative electrode can be provided.

### [2] Lithium Secondary Battery

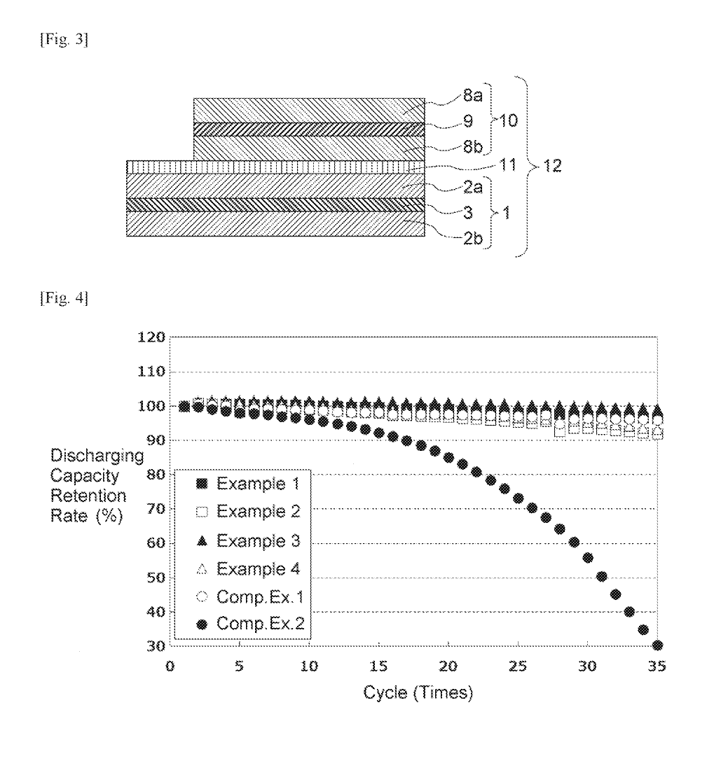

The negative electrode for a lithium secondary battery of the present invention is used as an electrode of a lithium secondary battery. As an example, the structure of a film-packaged stacked lithium secondary battery 7 will be described. The film-packaged stacked lithium secondary battery 7 according to the example embodiment is constituted of an electrode stack 12 sandwiched by film exteriors 13a and 13b, as shown in FIG. 2. The electrode stack 12 is a stack obtained by stacking the negative electrode 1 for a lithium secondary battery of the present invention and a positive electrode 10 constituted of a positive electrode current collector 9 having positive electrode active material layers 8a, 8b formed onto both surfaces thereof by coating, with a separator 11 interposed therebetween, as shown in FIG. 3. The number of layers of the electrode stack 12 is not limited to two, as shown in FIG. 3. The negative electrode 1 and the positive electrode 10 can be alternately stacked in any number of times. The negative electrode current collector 3 and the positive electrode current collector 9 partly protrude from the negative electrode active material layer 2a, 2b, and the positive electrode active material layer 8a, 8b, respectively. The protrusions from each of the positive and negative electrode collectors are collectively connected by, e.g., fusion bonding, to a negative electrode terminal 16 and a positive electrode terminal 15, respectively. The electrode stack 12 is united by an electrode stack binding tape 14. The films 13a, 13b each has a resin layer.

The film-packaged stacked lithium secondary battery 7 is produced from the electrode stack 12 and the film exteriors 13a, 13b, for example, as follows. The electrode stack 12 is sandwiched by the film exteriors 13a, 13b. An inlet is provided on the side of the film exteriors 13a, 13b except the side where the positive electrode terminal 15 and the negative electrode terminal 16 are present. The three sides except the side having the inlet are heat-sealed. Subsequently, the side at which positive and negative electrode terminals are present is allowed to face the bottom or a different side having no terminals is turned up, and then, an electrolytic solution (not shown) is introduced. Finally, the side having the inlet is heat-sealed to complete the production of a battery. As the film exteriors 13a, 13b each having a resin layer, for example, an aluminum laminate film having high corrosion resistance is used. Note that both ends of the side having the inlet can be heat-welded to narrow the inlet. In FIG. 2, the positive electrode terminal 15 and the negative electrode terminal 16 are provided in the same side; however, they can be provided in different sides.

The positive electrode 10 and the negative electrode 1 are prepared. The positive electrode 10 and the negative electrode 1 are stacked with the separator 11 interposed therebetween to form the electrode stack 12, as shown in FIG. 3. As the positive electrode current collector 9, a metal foil primarily formed of, for example, iron or aluminum, is used. In the negative electrode current collector 3, a metal foil primarily formed of, for example, copper or iron, is used. Furthermore, to the electrode stack 12, the positive electrode terminal 15 and the negative electrode terminal 16 are provided. These electrode terminals are sandwiched by the film package 13 and allowed to protrude outside. The both surfaces of each of the positive electrode terminal 15 and the negative electrode terminal 16, can be coated with a resin in order to improve, e.g., thermal adhesiveness of the positive electrode terminal 15 and the negative electrode terminal 16 with the film package 13. Such a resin can use a material having high adhesiveness to the metal employed in the electrode terminals.

[Film Package]

The film package 13 can use a material prepared by providing a resin layer on the front and back surfaces of a substrate, i.e., a metal layer. As the metal layer, a metal layer having a barrier property, such as a property of preventing electrolytic solution leakage and a property of preventing moisture invasion from outside, can be selected, and e.g., aluminum and stainless steel can be used. On at least one of the surfaces of the metal layer, a heat-sealable resin layer such as a modified polyolefin layer is provided. Further, a heat-sealable resin layer is provided onto the surfaces of the electrode stack 12 each facing to the film exteriors 13a and 13b so that the heat-sealable resin layers are arranged to face each other and the periphery of a portion in which the electrode stack 12 is to be housed is heat-sealed to form an outer container. On the surfaces of the film exteriors opposite to the surface having the heat-sealable resin layer formed thereon, a resin layer such as a nylon film or a polyester film can be provided.

[Non-Aqueous Electrolytic Solution]

In the example embodiment, a non-aqueous electrolytic solution is used as the electrolytic solution. The non-aqueous electrolytic solution is prepared by dissolving an electrolytic salt in a non-aqueous solvent. As the non-aqueous solvent, for example, the following organic solvents can be used. Examples of the organic solvents include cyclic carbonates, linear carbonates, aliphatic carboxylic acid esters, γ-lactones such as γ-butyrolactone, linear ethers, cyclic ethers, phosphoric acid esters and fluorides of these organic solvents. These can be used alone or as a mixture of two or more thereof. To these organic solvents, a lithium salt which is a kind of the electrolytic salt, and a functional additive(s) can be dissolved.

Examples of the cyclic carbonates can include, but are not particularly limited to, ethylene carbonate (EC), propylene carbonate (PC), butylene carbonate (BC) and vinylene carbonate (VC). As the fluorinated cyclic carbonates, e.g., compounds prepared by substituting part or whole hydrogen atoms of the cyclic carbonates with fluorine atoms, can be mentioned. More specifically, for example, 4-fluoro-1,3-dioxolan-2-one (also referred to as monofluoroethylene carbonate), (cis or trans) 4,5-difluoro-1,3-dioxolan-2-one, 4,4-difluoro-1,3-dioxolane-2-one and 4-fluoro-5-methyl-1,3-dioxolan-2-one can be used. Of the cyclic carbonates listed above, e.g., ethylene carbonate, propylene carbonate and 4-fluoro-1,3-dioxolan-2-one are preferable as the cyclic carbonates, in view of withstand voltage and conductivity. The cyclic carbonates can be used alone or in combination of two or more thereof.

Examples of the linear carbonates include, but are not particularly limited to, dimethyl carbonate (DMC), ethylmethyl carbonate (EMC), diethyl carbonate (DEC) and dipropyl carbonate (DPC). As the linear carbonate, a fluorinated linear carbonate is included. As the fluorinated linear carbonate, for example, compounds prepared by substituting part or whole hydrogen atoms of the linear carbonates with fluorine atoms can be mentioned. Specific examples of the fluorinated linear carbonate include bis(fluoroethyl) carbonate, 3-fluoropropylmethyl carbonate and 3,3,3-trifluoropropylmethyl carbonate. Of these, dimethyl carbonate is preferably in view of withstand voltage and conductivity. The linear carbonate can be used alone or in combination of two or more thereof.

Examples of the aliphatic carboxylic acid esters include, but are not particularly limited to, ethyl acetate, methyl propionate, ethyl formate, ethyl propionate, methyl butyrate, ethyl butyrate, methyl acetate and methyl formate. In the carboxylic acid ester, a fluorinated carboxylic acid ester is included. As the fluorinated carboxylic acid ester, e.g., compounds prepared by substituting part or whole hydrogen atoms of ethyl acetate, methyl propionate, ethyl formate, ethyl propionate, methyl butyrate, ethyl butyrate, methyl acetate or methyl formate, with fluorine atoms, can be mentioned. Examples thereof that can be used include ethyl pentafluoropropionate, ethyl 3,3,3-trifluoropropionate, methyl 2,2,3,3-tetrafluoropropionate, 2,2-difluoroethyl acetate, methyl heptafluoroisobutyrate, methyl 2,3,3,3-tetrafluoropropionate, methyl pentafluoropropionate, methyl 2-(trifluoromethyl)-3,3,3-trifluoropropionate, ethyl heptafluorobutyrate, methyl 3,3,3-trifluoropropionate, 2,2,2-trifluoroethyl acetate, isopropyl trifluoroacetate, tert-butyl trifluoroacetate, ethyl 4,4,4-trifluorobutyrate, methyl 4,4,4-trifluorobutyrate, butyl 2,2-difluoroacetate, ethyl difluoroacetate, n-butyl trifluoroacetate, 2,2,3,3-tetrafluoropropyl acetate, ethyl 3-(trifluoromethyl)butyrate, methyl tetrafluoro-2-(methoxy)propionate, 3,3,3-trifluoropropyl-3,3,3-trifluoropropionate, methyl difluoroacetate, 2,2,3,3-tetrafluoropropyl trifluoroacetate, 1H,1H-heptafluorobutyl acetate, methyl heptafluorobutyrate and ethyl trifluoroacetate.

Examples of the linear ethers include, but are not particularly limited to, dipropyl ether, ethyl tert-butyl ether, 2,2,3,3,3-pentafluoropropyl-1,1,2,2-tetrafluoroethyl ether, 1,1,2,2-tetrafluoroethyl-2,2,2-trifluoroethyl ether, 1H, 1H,2′H,3H-decafluorodipropyl ether, 1,1,2,3,3,3-hexafluoropropyl-2,2-difluoroethyl ether, isopropyl 1,1,2,2-tetrafluoroethyl ether, propyl 1,1,2,2-tetrafluoroethyl ether, 1,1,2,2-tetrafluoroethyl 2,2,3,3-tetrafluoropropyl ether, 1H, 1H,5H-perfluoropentyl-1,1,2,2-tetrafluoroethyl ether, 1H-perfluorobutyl-1H-perfluoroethyl ether, methyl perfluoropentyl ether, methyl perfluorohexyl ether, methyl 1,1,3,3,3-pentafluoro-2-(trifluoromethyl)propyl ether, 1,1,2,3,3,3-hexafluoropropyl 2,2,2-trifluoroethyl ether, ethyl nonafluorobutyl ether, ethyl 1,1,2,3,3,3-hexafluoropropyl ether, 1H,1H,5H-octafluoropentyl 1,1,2,2-tetrafluoroethyl ether, 1H,1H,2′H-perfluorodipropyl ether, heptafluoropropyl 1,2,2,2-tetrafluoroethyl ether, 1,1,2,2-tetrafluoroethyl-2,2,3,3-tetrafluoropropyl ether, 2,2,3,3,3-pentafluoropropyl-1,1,2,2-tetrafluoroethyl ether, ethyl nonafluorobutyl ether, methyl nonafluorobutyl ether, 1,1-difluoroethyl-2,2,3,3-tetrafluoropropyl ether, bis(2,2,3,3-tetrafluoropropyl) ether, 1,1-difluoroethyl-2,2,3,3,3-pentafluoropropyl ether, 1,1-difluoroethyl-1H, 1H-heptafluorobutyl ether, 2,2,3,4,4,4-hexafluorobutyl-difluoromethyl ether, bis(2,2,3,3,3-pentafluoropropyl) ether, nonafluorobutyl methyl ether, bis(1H,1H-heptafluorobutyl) ether, 1,1,2,3,3,3-hexafluoropropyl-1H,1H-heptafluorobutyl ether, 1H, 1H-heptafluorobutyl-trifluoromethyl ether, 2,2-difluoroethyl-1,1,2,2-tetrafluoroethyl ether, bis(trifluoroethyl) ether, bis(2,2-difluoroethyl) ether, bis(1,1,2-trifluoroethyl) ether, 1,1,2-trifluoroethyl-2,2,2-trifluoroethyl ether and bis(2,2,3,3-tetrafluoropropyl) ether.

As the cyclic ethers, although they are not particularly limited to, e.g., tetrahydrofuran, 2-methyltetrahydrofuran, 1,3-dioxolane and 2-methyl-1,3-dioxolane are preferable. Cyclic ethers partly fluorinated such as 2,2-bis(trifluoromethyl)-1,3-dioxolane and 2-(trifluoroethyl) dioxolane can be used.

Examples of the phosphoric acid ester compounds include, but are not particularly limited to, trimethyl phosphate, triethyl phosphate, tripropyl phosphate, 2,2,2-trifluoroethyldimethyl phosphate, bis(trifluoroethyl)methyl phosphate, bistrifluoroethylethyl phosphate, tris(trifluoromethyl) phosphate, pentafluoropropyldimethyl phosphate, heptafluorobutyldimethyl phosphate, trifluoroethylmethylethyl phosphate, pentafluoropropylmethylethyl phosphate, heptafluorobutylmethylethyl phosphate, trifluoroethylmethylpropyl phosphate, pentafluoropropylmethylpropyl phosphate, heptafluorobutylmethylpropyl phosphate, trifluoroethylmethylbutyl phosphate, pentafluoropropylmethylbutyl phosphate, heptafluorobutylmethylbutyl phosphate, trifluoroethyldiethyl phosphate, pentafluoropropyldiethyl phosphate, heptafluorobutyldiethyl phosphate, trifluoroethylethylpropyl phosphate, pentafluoropropylethylpropyl phosphate, heptafluorobutylethylpropyl phosphate, trifluoroethylethylbutyl phosphate, pentafluoropropylethylbutyl phosphate, heptafluorobutylethylbutyl phosphate, trifluoroethyldipropyl phosphate, pentafluoropropyldipropyl phosphate, heptafluorobutyldipropyl phosphate, trifluoroethylpropylbutyl phosphate, pentafluoropropylpropylbutyl phosphate, heptafluorobutylpropylbutyl phosphate, trifluoroethyldibutyl phosphate, pentafluoropropyldibutyl phosphate, heptafluorobutyldibutyl phosphate, tris(2,2,3,3-tetrafluoropropyl) phosphate, tris(2,2,3,3,3-pentafluoropropyl) phosphate, tris(2,2,2-trifluoroethyl) phosphate, tris(1H,1H-heptafluorobutyl) phosphate and tris(1H,1H,5H-octafluoropentyl) phosphate.

Examples of the supporting electrolyte for the electrolyte include lithium salts such as LiPF₆, LiAsF₆, LiAlCl₄, LiClO₄, LiBF₄, LiSbF₆, LiCF₃SO₃, LiC₄F₉SO₃, LiC(CF₃SO₂)₃, LiN(CF₃SO₂)₂, LiN(C₂F₅SO₂)₂ and LiB₁₀Cl₁₀. Other examples of the supporting electrolyte include a lithium salt of a lower aliphatic carboxylic acid, chloroborane lithium, lithium tetraphenylborate, LiBr, LiI, LiSCN and LiCl. The supporting electrolytes can be used alone or in combination of two types or more. The concentration of the supporting electrolyte preferably falls within the range of 0.3 mol/l or more and 5 mol/l in the electrolytic solution.

[Positive Electrode]

The positive electrode is formed, for example, by bonding a positive electrode active material to a positive electrode current collector with a positive electrode binder. Examples of the positive electrode material (positive electrode active material) include, but are not particularly limited to, a laminar material, a spinel material and an olivine material. The laminar material is represented by general formula: LiMO₂ (M represents a metal element) and more specifically, includes lithium metal composite oxides having a layered structure and represented by

LiCo₁₋ₓMₓO₂ (0≤x<0.3, M represents a metal except Co);

Li_{y}Ni₁₋ₓMₓO₂ (A)

(In the formula (A), 0≤x<0.8, 0<y≤1.0 and M represents at least one element selected from the group consisting of Co, Al, Mn, Fe, Ti and B). In particular,

LiNi₁₋ₓMₓO₂ (0.05<x<0.3, M represents a metal element including at least one element selected from Co, Mn and Al);

Li(LiₓM_{1-x-z}Mn_{z})O₂ (B)

(In the formula (B), 0.1≤x<0.3, 0.33≤z≤0.8, and M is at least one of Co and Ni); and

Li(M_{1-z}Mn_{z})O₂ (C)

(In the formula (C), 0.33≤z≤0.7, M is at least one of Li, Co and Ni).

In the above formula (A), the content of Ni is preferably high, in other words, x is preferably less than 0.5 and further preferably 0.4 or less. Examples of such a compound include Li_{α}Ni_{β}Co_{γ}Mn_{δ}O₂ (1≤α≤1.2, β+γ+δ=1, β≥0.6, γ≤0.2) and Li_{α}Ni_{β}Co_{γ}Al_{δ}O₂ (1≤α≤1.2, β+γ+δ=1, β≥0.6, γ≤0.2). Particularly, LiNi_{β}Co_{γ}Mn_{δ}O₂ (0.75≤β≤0.85, 0.05≤γ≤0.15, 0.10≤δ≤0.20) is mentioned. More specifically, for example, LiNi_{0.8}Co_{0.05}Mn_{0.15}O₂, LiNi_{0.8}Co_{0.1}Mn_{0.12}, LiNi_{0.8}Co_{0.15}Al_{0.05}O₂, LiNi_{0.8}Co_{0.1}Al_{0.1}O₂ and LiNi_{0.6}Co_{0.2}Mn_{0.2}O₂ can be preferably used.

In view of thermal stability, it is preferable that the content of Ni does not exceed 0.5; in other words, in the formula (A), x is 0.5 or more. It is also preferable that the content of a predetermined transition metal does not exceed the half. As such a compound, Li_{α}Ni_{β}Co_{γ}Mn_{δ}O₂ (1≤α≤1.2, β+γ+δ=1, 0.2≤β≤0.5, 0.1≤γ≤0.4, 0.1≤δ≤0.4) is mentioned. More specifically, e.g., LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), LiNi_{0.5}Co_{0.3}Mn_{0.2}O₂ (abbreviated as NCM532) and LiNi_{0.4}Mn_{0.4}Co_{0.2}O₂ can be mentioned (however, in these compounds, the contents of individual transition metals can vary within about 10%).

In the above formula (B), Li(Li_{0.2}Ni_{0.2}Mn_{0.6})O₂, Li(Li_{0.15}Ni_{0.3}Mn_{0.55})O₂, Li(Li_{0.15}Ni_{0.2}Co_{0.1}Mn_{0.55})O₂, Li(Li_{0.15}Ni_{0.15}Co_{0.15}Mn_{0.55})O₂ and Li(Li_{0.15}Ni_{0.1}Co_{0.2}Mn_{0.55})O₂ are preferable.

Examples of the spinel material that can be used include:

LiMn₂O₄;

a material enhanced in lifespan by partially substituting Mn of LiMn₂O₄ and operated at about 4 V with respect to lithium, for example,

LiMn₂₋ₓMₓO₄ (in the formula, 0<x<0.3, M represents a metal element including at least one metal selected from Li, Al, B, Mg, Si and a transition metal);

a material represented operated at a high voltage of about 5 V such as LiNi_{0.5}Mn_{1.5}O₄; and

a material, which has components similar to LiNi_{0.5}Mn_{1.5}O₄, and is obtained by substituting a part of the material of LiMn₂O₄ with a transition metal, charged/discharged at a high potential and further adding another element, for example, represented by

Liₐ(MₓMn_{2-x-y}Y_{y})(O_{4-w}Z_{w}) (D)

(in the formula (D), 0.4≤x≤1.2, 0≤y, x+γ<2, 0≤a≤1.2, 0≤w≤1; M represents a transition metal element and contains at least one element selected from the group consisting of Co, Ni, Fe, Cr and Cu; Y represents a metal element and contains at least one element selected from the group consisting of Li, B, Na, Al, Mg, Ti, Si, K and Ca; and Z represents at least one element selected from the group consisting of F and Cl).

In the formula (D), M preferably contains a transition metal element selected from the group consisting of Co, Ni, Fe, Cr and Cu, in a proportion of 80% or more of the composition ratio x, more preferably 90% or more and acceptably 100%; Y contains a metal element selected from the group consisting of Li, B, Na, Al, Mg, Ti, Si, K and Ca preferably in a proportion of 80% or more of the composition ratio y, more preferably 90% or more and acceptably 100%.

The olivine material is represented by general formula:

LiMPO₄ (E)

(in the formula (E), M represents at least one element of Co, Fe, Mn and Ni).

More specifically, e.g., LiFePO₄, LiMnPO₄, LiCoPO₄ and LiNiPO₄ are mentioned. Materials in which these constituent elements are partly substituted with another element, for example, parts of oxygen atoms are substituted with fluorine atoms, can be used.

Other than these, as a positive electrode active material, e.g., a NASICON-structured material and a lithium transition metal silicon composite oxide can be used. The positive electrode active materials can be used alone and as a mixture of two or more thereof.

Of these positive electrode active materials, positive electrode active materials represented by general formulas (A), (B), (C) and (D) are particularly preferable, because an effect of increasing the energy density of the battery can be expected.

The specific surface areas of these positive electrode active materials are, for example, 0.01 to 20 m²/g, preferably 0.05 to 15 m²/g, more preferably 0.1 to 10 m²/g and further preferably 0.15 to 8 m²/g. If the specific surface area falls within the above range, the contact area with the electrolytic solution can be controlled to fall within an appropriate range. More specifically, if the specific surface area is 0.01 m²/g or more, lithium ions tend to smoothly enter and leave, with the result that resistance can be further reduced. In contrast, if the specific surface area is 8 m²/g or less, promotion of decomposing the electrolytic solution and elution of constituent elements of the active material can be further suppressed.

The central particle size of the lithium composite oxide particles is preferably 0.01 to 50 m and more preferably 0.02 to 40 μm. If the particle size is 0.01 μm or more, elution of constituent elements of the positive electrode material can be further suppressed and deterioration of the positive electrode material in contact with the electrolytic solution can be further suppressed. If the particle size is 50 μm or less, lithium ions tend to smoothly enter and leave, with the result the resistance can be further reduced. The particle size can be measured by a laser diffraction/scattering particle size distribution measuring device.

To the positive electrode active material layers 8a, 8b, a conductive aid and a binder are added. As the conductive aid, e.g., carbon black, carbon fiber and graphite can be used alone or in combination of two or more thereof. Examples of the binder that can be used include polyimide, polyamide, polyacrylic acid, polyvinylidene fluoride, polytetrafluoroethylene, carboxymethyl cellulose and modified acrylonitrile rubber particles.

[Current Collector]

As the positive electrode current collector 9, aluminum, stainless steel, nickel, cobalt, titanium, gadolinium or alloys of them can be used.

[Separator]

The material of the separator 11 is not particularly limited as long as it is a material such as a nonwoven fabric and a microporous membrane generally used in nonaqueous electrolytic solution secondary batteries. As an example of the material, a polyolefin resin such as polypropylene and polyethylene, a polyester resin, an acrylic resin, a styrene resin, or a nylon resin can be used. Particularly, a polyolefin microporous membrane is preferable since it is excellent in ion permeability and physically isolation of the positive electrode and the negative electrode. If necessary, a layer containing inorganic particles can be formed on the separator 11. Examples of the inorganic particles include insulating oxide, nitride, sulfide and carbide. Of them, the inorganic particles preferably include SiO₂, TiO₂ and Al₂O₃. Furthermore, a flame retardant resin having a high melting point such as aramid and polyimide, can be used. In order to increase the impregnating ability of the electrolytic solution, a material having a small contact angle of the electrolytic solution with the separator 11 is preferably selected. In order to keep satisfactory ion permeability and appropriate thrust strength, the film thickness is 5 to 25 μm and further preferably 7 to 16 μm.

### [2] Production Method

Now, a method for producing the film-packed stacked lithium secondary battery 7 according to an example embodiment of the present invention will be described below.

First, for the electrodes for a secondary battery, the positive electrode 10 having the positive electrode active material layers 8a, 8b formed on both surfaces of the positive electrode current collector 9 and the negative electrode 1 having the negative electrode active material layers 2a, 2b formed on both surfaces of the negative electrode current collector 3, are prepared, as shown in FIG. 3. More specifically, the positive electrode active material layers 8a, 8b are formed on the positive electrode current collector 9 by applying a predetermined amount of slurry. Thereafter, the positive electrode active material layers 8a, 8b on the positive electrode current collector 9 are pressed with appropriate pressure. In the same manner, the negative electrode active material layers 2a, 2b are formed on the negative electrode current collector 3 by applying and the negative electrode active material layers 2a, 2b are pressed. The positive electrode 10 and the negative electrode 1 thus prepared are alternately stacked with the separator 11 interposed therebetween to form the electrode stack 12. The number of layers of the positive electrodes 10 and the negative electrodes 1 to be stacked are determined based on, e.g., application of the resultant secondary battery.

Next, as shown in FIG. 2, the film exteriors 13a, 13b are overlaid on the outer surfaces of the electrode stack 12, respectively. The outer peripheries of the film exteriors 13a, 13b overlaid are mutually joined by, e.g., welding except the portion having an inlet (not shown). A pair of electrode terminals, i.e., the positive electrode terminal 15 and the negative electrode terminal 16, are connected to the positive electrode 10 and the negative electrode 1, respectively, and allowed to protrude out of the film package 13. At the portion of the package, through which the positive electrode terminal 15 and the negative electrode terminal 16 pass, the film exteriors 13a, 13b are not directly welded. The positive electrode terminal 15 is joined to each of the film exteriors 13a, 13b; and the negative electrode terminal 16 is joined to each of the film exteriors 13a, 13b. The film exteriors 13a, 13b around the positive electrode terminal 15 and the negative electrode terminal 16 are mutually and tightly joined. In this manner, the battery is sealed substantially without space.

While the electrode stack 12 is housed in the film package 13, which is sealed except the inlet, the electrolytic solution (not shown) is introduced into the film package 13 through the inlet. In order to seal the inlet of the film package 13 housing the electrode stack 12 and the electrolytic solution, unsealed outer peripheral portions of the film exteriors 13a, 13b are mutually joined by, e.g., welding. In this manner, the entire periphery of the film package 13 is sealed.

FIG. 3 shows a case where a single positive electrode 10 and a single negative electrode 1 are used, for simplifying the explanation; however, the present invention can be applied to the case where a plurality of positive electrodes 10 and a plurality of negative electrodes 1 are stacked. In the case of using a plurality of electrodes, the requisite number of laminates each constituted of the separator 11, positive electrode 10, separator 11, negative electrode 1 in this order are continuously disposed under the negative electrode active material layer 2b shown in FIG. 3. The positive electrode 10 and the negative electrode 1 serving as the bottom layer or the top layer, can be accepted if an active material layer is formed on one of the surfaces of the collector. In this case, the negative electrode 1 and the positive electrode 10 facing these can be stacked such that the active material layers of them mutually face, with the separator 11 interposed therebetween.

### [3] Other Example Embodiments of the Present Invention

In the aforementioned example embodiments, an electrolytic solution is used; however, e.g., a solid electrolyte containing an electrolytic salt, a polymer electrolyte, a solid state or gel-state electrolyte prepared by mixing or dissolving an electrolytic salt to e.g., a polymer compound can be also used. These can serve also as a separator.

In the aforementioned example embodiments, a battery having a laminate of electrodes is described; the present invention can employ a roll design of electrodes and can be applied to a cylindrical and prismatic batteries.

In the aforementioned example embodiments, a lithium ion secondary battery is described; however, the present invention is effective if it is applied to a secondary battery other than lithium ion secondary batteries.

### EXAMPLES

Now, the effect of an example embodiment will be specifically described by way of Examples and Comparative Examples.

### Example 1

[Production of Positive Electrode]

93% by mass of overlithiated lithium manganate (Li_{1.2}Ni_{0.2}Mn_{0.6}O₂), 3% by mass of powdery polyvinylidene fluoride and 4% by mass of powdery graphite were homogeneously mixed to prepare a positive-electrode mix. The positive-electrode mix prepared was dispersed in N-methyl-2-pyrrolidone (NMP) to prepare a positive-electrode mix slurry. The positive-electrode mix slurry was uniformly applied to one of the surfaces of aluminum (Al) foil serving as a positive electrode current collector, dried at about 120° C., molded and pressurized by using a punching die and a press machine to form a rectangle positive electrode. Note that, the unit weight of the positive electrode was set to be 20 g/cm² and the density of the positive electrode was set to be 2.9 g/cm³.

[Production of Negative Electrode]

A negative electrode active material (85 mass %), which was prepared by mixing carbon-coated silicon oxide (abbreviated as SiOC) particles having a D50 of 5 μm and boron-added Si alloy (Si_{0.98}B_{0.02}) particles having a D50 of 0.4 μm in the ratio of 95 (mass %):5 (mass %); a polyimide binder (13 mass %) and fibrous graphite (2 mass %) were homogeneously mixed to prepare a negative-electrode mix. The negative-electrode mix was dispersed in NMP to prepare a negative-electrode mix slurry. Subsequently, the negative-electrode mix slurry was applied one of the surfaces of stainless steel (SUS) foil, dried at about 90° C., further dried at 350° C. in a nitrogen atmosphere, and molded into a rectangle negative electrode by a punching die. Note that, the outer size of sides of the negative electrode is set to be larger by 1 mm than the outer size of the positive electrode. The unit weight of the negative electrode was set to be 2.6 g/cm² and the density of the negative electrode was set to be 1.31 g/cm³. Note that, a nonaqueous polyimide binder was used herein; however, an aqueous binder such as SBR (styrene butadiene copolymer), CMC (sodium carboxymethyl cellulose), a mixture of SBR and CMC, PAA (polyacrylic acid) and an aqueous polyimide binder can be used with water as a dispersion medium in preparing slurry.

[Production of Electrolytic Solution]

Ethylene carbonate (EC), tris(2,2,2-trifluoroethyl) phosphate (TTFEP) and 1,1,2,2-tetrafluoroethyl-2,2,3,3-tetrafluoropropyl ether (FE1) were mixed in volume ratio of EC/TTFEP/FE1=2/3/5 and dissolved in 0.8 mol/l LiPF₆ to prepare an electrolytic solution.

[Production of Stacked Non-Aqueous Electrolyte Secondary Battery]

A positive electrode having a positive electrode terminal connected thereto and a negative electrode having a negative electrode terminal connected thereto were stacked such that the active material layers of them face each other with a porous aramid separator (15 μm) interposed therebetween to produce an electrode stack. At the stacking, the positive electrode and the negative electrode were staked so that the clearance between the edge of the positive electrode and the edge of the negative electrode in each side became 1 mm. The electrode stack was sandwiched by film exteriors made of aluminum laminate film. The outer periphery except the inlet was heat-sealed and the electrolytic solution prepared above was introduced through the inlet. Thereafter, the inlet was sealed by heat-sealed to produce a stacked lithium ion secondary battery. Note that, with respect to the electrode area, provided that the ratio of the initial charging capacity per unit area of the negative electrode and the initial charging capacity per unit area of the positive electrode is represented by A (negative electrode)/C (positive electrode), a ratio of A/C was set to be 1.1.

### Example 2

A rectangle negative electrode was formed in the same manner as in Example 1 by using a negative electrode active material prepared by mixing SiOC and Si_{0.98}B_{0.02} (D50: 0.4 μm) in a ratio of 85 (mass %):15 (mass %). Note that the unit weight of the negative electrode was set to be 2.4 g/cm² and the density of the negative electrode was set to be 1.36 g/cm³. A stacked lithium ion secondary battery was produced by using the positive electrode, separator and electrolytic solution of Example 1 so as to have A/C=1.1.

### Example 3

A rectangle negative electrode was formed in the same manner as in Example 1 by using a negative electrode active material prepared by mixing SiOC and tin-added Si alloy (Si_{0.93}Sn_{0.07}) (D50: 0.4 μm) in a ratio of 95 (mass %):5 (mass %). Note that the unit weight of the negative electrode was set to be 2.7 g/cm² and the density of the negative electrode was set to be 1.32 g/cm³. A stacked lithium ion secondary battery was produced by using the positive electrode, separator and electrolytic solution of Example 1 so as to have A/C=1.1.

### Example 4

A rectangle negative electrode was formed in the same manner as in Example 1 by using a negative electrode active material prepared by mixing SiOC and Si_{0.93}Sn_{0.07} (D50: 0.4 μm) in a ratio of 85 (mass %):15 (mass %). Note that the unit weight of the negative electrode was set to be 2.6 g/cm² and the density of the negative electrode was set to be 1.36 g/cm³. A stacked lithium ion secondary battery was produced by using the positive electrode, separator and electrolytic solution of Example 1 so as to have A/C=1.1.

### Example 5

A rectangle negative electrode was formed in the same manner as in Example 1 by using a negative electrode active material prepared by mixing SiOC and titanium-added Si alloy (Si_{0.95}Ti_{0.05}) (D50: 0.5 μm) in a ratio of 95 (mass %):5 (mass %). Note that the unit weight of the negative electrode was set to be 2.7 g/cm² and the density of the negative electrode was set to be 1.32 g/cm³. A stacked lithium ion secondary battery was produced by using the positive electrode, separator and electrolytic solution of Example 1 so as to have A/C=1.1.

### Example 6

A negative electrode was formed in the same manner as in Example 1 by using a negative electrode active material prepared by mixing SiOC and aluminum-added Si alloy (Si_{0.95}Al_{0.05}) (D50: 0.6 μm) in a ratio of 95 (mass %):5 (mass %). Note that the unit weight of the negative electrode was set to be 2.7 g/cm² and the density of the negative electrode was set to be 1.32 g/cm³. A stacked lithium ion secondary battery was produced by using the positive electrode, separator and electrolytic solution of Example 1 so as to have A/C=1.1.

### Example 7

A rectangle negative electrode was formed in the same manner as in Example 1 by using a negative electrode active material prepared by mixing SiOC and chromium-added Si alloy (Si_{0.95}Cr_{0.05}) (D50: 0.6 μm) in a ratio of 95 (mass %):5 (mass %). Note that the unit weight of the negative electrode was set to be 2.7 g/cm² and the density of the negative electrode was set to be 1.31 g/cm³. A stacked lithium ion secondary battery was produced by using the positive electrode, separator and electrolytic solution of Example 1 so as to have A/C=1.1.

### Example 8

A rectangle negative electrode was formed in the same manner as in Example 1 by using a negative electrode active material prepared by mixing SiOC and copper-added Si alloy (Si_{0.95}Cu_{0.05}) (D50: 0.5 μm) in a ratio of 95 (mass %):5 (mass %). Note that, the unit weight of the negative electrode was set to be 2.7 g/cm² and the density of the negative electrode was set to be 1.31 g/cm³. A laminated lithium ion secondary battery was produced by using the positive electrode, separator and electrolytic solution of Example 1 so as to have A/C=1.1.

### Comparative Example 1

A negative-electrode mix was prepared by homogeneously mixing SiOC (85 mass %), a polyimide binder (13 mass %) and fibrous graphite (2 mass %) and dispersed in N-methyl-2-pyrrolidone (NMP) to obtain a negative-electrode mix slurry. Subsequently, a rectangle negative electrode was formed in the same manner as in Example 1 by using the negative-electrode mix slurry. Note that, the unit weight of the negative electrode was set to be 2.6 g/cm² and the density of the negative electrode was set to be 1.23 g/cm³. A stacked lithium ion secondary battery was produced by using the positive electrode, separator and electrolytic solution of Example 1 so as to have A/C=1.1.

### Comparative Example 2

A rectangle negative electrode was formed in the same manner as in Example 1 by using a negative electrode active material prepared by mixing SiOC and boron-added Si alloy (Si_{0.9}B_{0.1}) (D50: 10 μm) in a ratio of 95 (mass %):5 (mass %). Note that, the unit weight of the negative electrode was set to be 2.7 g/cm² and the density of the negative electrode was set to be 1.36 g/cm³. A stacked lithium ion secondary battery was produced by using the positive electrode, separator and electrolytic solution of Example 1 so as to have A/C=1.1.

### Comparative Example 3

A rectangle negative electrode was formed in the same manner as in Example 1 by using a negative electrode active material prepared by mixing SiOC and manganese-added Si alloy (Si_{0.95}Cu_{0.05}) (D50: 0.5 μm) in a ratio of 85 (mass %):15 (mass %). Note that, the unit weight of the negative electrode was set to be 2.6 g/cm² and the density of the negative electrode was set to be 1.35 g/cm³. A stacked lithium ion secondary battery was produced by using the positive electrode, separator and electrolytic solution of Example 1 so as to have A/C=1.1.

The levels of the negative electrodes using in Examples 1 to 8, Comparative Examples 1 to 3 are shown in Table 1.

TABLE 1
Table of Negative Electrode Levels

| | | | Si alloy/(Si alloy + | Kind of Si alloy | | Charging specific |
|---|---|---|---|---|---|---|
| | D50 (μm) | | SiOC) | (Si_{1-ψ}M_{ψ}) | | capacity of Si alloy |
| | Si Alloy | SiOC | Mass ratio ω (%) | M | ψ | (mAh/g) |
| Example 1 | 0.4 | 5 | 5 | B | 0.02 | 3700 |
| Example 2 | ↑ | ↑ | 15 | ↑ | ↑ | ↑ |
| Example 3 | 0.4 | ↑ | 5 | Sn | 0.07 | 3000 |
| Example 4 | ↑ | ↑ | 15 | ↑ | ↑ | ↑ |
| Example 5 | 0.5 | ↑ | 5 | Ti | 0.05 | ↑ |
| Example 6 | 0.6 | ↑ | ↑ | Al | ↑ | ↑ |
| Example 7 | 0.6 | ↑ | ↑ | Cr | ↑ | ↑ |
| Example 8 | 0.5 | ↑ | ↑ | Cu | ↑ | ↑ |
| Comp. Ex. 1 | — | ↑ | 0 | — | — | — |
| Comp. Ex. 2 | 10 | ↑ | 5 | B | 0.1 | 2600 |
| Comp. Ex. 3 | 0.5 | ↑ | 15 | Mn | 0.05 | 2800 |

Stacked lithium secondary batteries produced in Examples and Comparative Examples were subjected to repeating cycles four times in an environment of 45° C. In each cycle, the batteries were constantly charged at a current value of 0.1 C up to 4.5 V and constantly discharged at a current value of 0.1 C up to 1.5 V. The charge/discharge efficiency obtained in the first cycle, and the volumetric energy density obtained in the fourth cycle in each level are shown together with the electrode density in Table 2. The volumetric energy densities mentioned in Table 2 were obtained by calculating the discharge energy based on the discharge capacity at the fourth discharge time and average discharge voltage and dividing the discharge energy by the cell volume. Note that, the cell volume was obtained by multiplying the laminate area of an outer package and the thickness of the cell. Note that, unit C represents a relative current amount, and 0.1 C means a current value at which the discharge is completed in just 10 hours by discharging a constant current with a battery having a capacity of a nominal capacity value.

TABLE 2

| | Electrode density | Volumetric | Initial charge/ |
|---|---|---|---|
| | without pressing | energy density | discharge efficiency |
| | (g/cm³) | (Wh/L) | (%) |
| Example 1 | 1.31 | 697 | 69.1 |
| Example 2 | 1.36 | 724 | 69.9 |
| Example 3 | 1.32 | 684 | 69.1 |
| Example 4 | 1.36 | 704 | 69.5 |
| Example 5 | 1.32 | 688 | 69.2 |
| Example 6 | 1.32 | 691 | 69.3 |
| Example 7 | 1.31 | 696 | 69.8 |
| Example 8 | 1.31 | 689 | 69.6 |
| Comp. Ex. 1 | 1.23 | 669 | 67.9 |
| Comp. Ex. 2 | 1.36 | 649 | 57.3 |
| Comp. Ex. 3 | 1.35 | 710 | 68.8 |

As is apparent from Table 2, the electrode density, volumetric energy density and initial charge/discharge efficiency in each of Examples 1 to 8 are higher than in Comparative Example 1 employing no Si alloy. In addition, in Comparative Example 2 where the central particle size D50 of Si alloy is larger than the central particle size D50 of SiO_{χ}, since the initial charge/discharge efficiency is low, the volumetric energy density is also low.

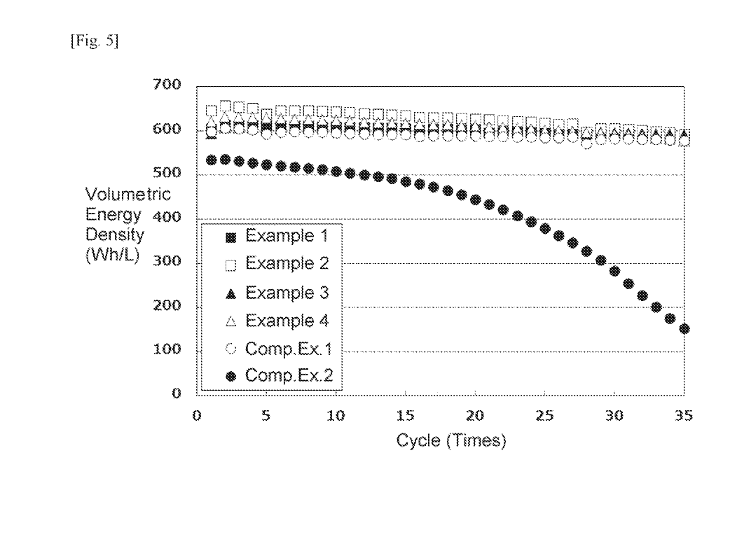

Subsequently, cycle characteristic was evaluated by repeating a cycle consisting of constant current charge at a current value of 0.3 C up to 4.5 V and a constant current discharge at a current value of 0.3 C up to 1.5 V, 35 times. At this time, a change of the discharge capacity retention rate based on the discharge capacity at the first cycle as 100% is shown in FIG. 4, and a change of the volumetric energy density obtained from the discharge capacity per positive electrode active material in each cycle is shown in FIG. 5, by extracting each of Examples 1 to 4 and Comparative Examples 1 and 2. The discharge capacity retention rate after 35 cycles, volumetric energy density at the first cycle and volumetric energy density at 35th cycle of Examples 1 to 8, Comparative Examples 1 to 3 are shown in Table 3.

TABLE 3

| | discharge capacity | Volumetric | Volumetric |
|---|---|---|---|
| | retention rate after | energy density | energy density |
| | 35 cycles | at 1st cycle | at 35th cycle |
| | (%) | (Wh/L) | (Wh/L) |
| Example 1 | 96.5 | 604 | 585 |
| Example 2 | 91.8 | 646 | 593 |
| Example 3 | 99.2 | 594 | 592 |
| Example 4 | 93.2 | 621 | 578 |
| Example 5 | 95.5 | 600 | 582 |
| Example 6 | 96.1 | 610 | 590 |
| Example 7 | 96.0 | 608 | 588 |
| Example 8 | 95.7 | 601 | 581 |
| Comp. Ex. 1 | 96.0 | 599 | 579 |
| Comp. Ex. 2 | 30.3 | 599 | 535 |
| Comp. Ex. 3 | 50.1 | 620 | 552 |

As shown in Table 3, in Examples 2 and 4 where Si alloy addition amount was large, the discharge capacity retention rate after 35 cycles was lower than in Comparative Example 1; while each of the volumetric energy density at the first cycle was high than in Comparative Example 1. The volumetric energy density at the 35th cycle in Example 2 was higher than in Comparative Example 1 and the volumetric energy density at the 35th cycle in Example 4 was same as in Comparative Example 1. It is found that, in Examples 1, 3, 5 to 8 where Si alloy addition amount is low, the discharge capacity retention rate and both volumetric energy densities are larger than in Comparative Examples. Furthermore, it is found that, in Comparative Example 2 where the central particle size D50 of Si alloy is larger than the central particle size D50 of SiO_{χ}, the discharge capacity retention rate rapidly faded and shows an extremely low value at the 35th cycle. It was found that, in Comparative Example 3 employing Si alloy including Mn, the content of which in the positive electrode Li_{1.2}Ni_{0.2}Mn_{0.6}O₂ is the largest, the discharge capacity retention rate at the 35th cycle is lower than in Examples employing Si alloy including other elements. This is presumably because the elution amount of Mn from the positive electrode is large.

From the results mentioned above, the electrode density, and the initial charge/discharge efficiency were improved by mixing second particles composed of a Si alloy having a central particle size D50 smaller than that of first particles composed of SiO_{χ}, to the first particles, with the result that high volumetric energy density was obtained. This application is based upon and claims the benefit of priority from Japanese patent application No. 2016-082179, filed on Apr. 15, 2016, the disclosure of which is incorporated herein in its entirety by reference.

### INDUSTRIAL APPLICABILITY

The present invention can be applied to power supplies for mobile devices such as mobile phones and notebook computer; power supplies for electric vehicles such as electric cars, hybrid cars, electric motorcycles and electric assisted bicycles; power supplies for moving/transport mediums such as electric trains, satellites and submarines; and electricity storage systems for storing electricity.

### REFERENCE SIGNS LIST

1 Negative electrode
2a, 2b Negative electrode active material layer
3 Negative electrode current collector
4 First particles
5 Second particles
6 Binder
7 Film-packaged stacked lithium secondary battery
8a, 8b Positive electrode active material layer
9 Positive electrode current collector
10 Positive electrode
11 Separator
12 Electrode stack
13a, 13b Film exterior
14 Electrode stack binding tape
15 Positive electrode terminal
16 Negative electrode terminal

1. A negative electrode for a lithium secondary battery, having a negative electrode active material layer formed on a current collector, wherein
the negative electrode active material layer comprises at least first particles, second particles and a binder,
the first particles are formed of SiO_{χ} (0<χ<2.0),
the second particles are formed of a Si alloy, the Si alloy comprising Si and at least one element selected from metal elements except Li, Mn, Fe, Co and Ni and semimetal elements, and
a central particle size D50 of the first particles is larger than a central particle size D50 of the second particles.

2. The negative electrode for a lithium secondary battery according to claim 1, wherein the central particle size D50 of the first particles is 1 μm or more and 35 μm or less.

3. The negative electrode for a lithium secondary battery according to claim 1, wherein the central particle size D50 of the second particles is 0.1 μm or more and 5 μm or less.

4. The negative electrode for a lithium secondary battery according to claim 1, wherein a surface of the first particles is coated with carbon, a mass ratio of SiO_{χ} and carbon with which the surface is coated falls within the range of 99.9/0.1 to 80/20.

5. The negative electrode for a lithium secondary battery according to claim 1, wherein the second particles has an initial charging capacity of 1000 mAh/g or more and 4000 mAh/g or less when Li is used as a counter electrode.

6. The negative electrode for a lithium secondary battery according to claim 1, wherein provided that the Si alloy serving as the second particles is represented by Si_{1-ψ}M_{ψ} where M represents a metal or semimetal constituting the Si alloy together with Si, 0.01≤γ≤0.5 is satisfied.

7. The negative electrode for a lithium secondary battery according to claim 6, wherein the M is at least one selected from Be, Mg, Al, Sc, Ti, V, Cr, Cu, Zn, Ga, Y, Zr, Nb, Mo, Pd, Ru, Cd, In, Sn, Ta, W, Pt, Au, Pb, Bi, B, Ge, As, Sb and Te.

8. The negative electrode for a lithium secondary battery according to claim 1, wherein a mass ratio ω of the second particles relative to a total mass of the first particles and the second particles satisfies 0%<ω≤50%.

9. A lithium secondary battery using the negative electrode for a lithium secondary battery according to claim 1.

10. A lithium secondary battery using the negative electrode for a lithium secondary battery according to claim 2.

11. A lithium secondary battery using the negative electrode for a lithium secondary battery according to claim 3.

12. A lithium secondary battery using the negative electrode for a lithium secondary battery according to claim 4.

13. A lithium secondary battery using the negative electrode for a lithium secondary battery according to claim 5.

14. A lithium secondary battery using the negative electrode for a lithium secondary battery according to claim 6.

15. A lithium secondary battery using the negative electrode for a lithium secondary battery according to claim 7.

16. A lithium secondary battery using the negative electrode for a lithium secondary battery according to claim 8.
